(19) United States
(12) Patent Application Publication
(10) Pub. No.: US 2020/0275089 A1
(43) Pub. Date: Aug. 27, 2020

(54) INPUT METHOD AND APPARATUSES PERFORMING THE SAME

(71) Applicant: Korea Advanced Institute of Science and Technology, Daejeon (KR)

(72) Inventors: Geehyuk Lee, Daejeon (KR); Sunggeun Ahn, Daejeon (KR)

(73) Assignee: Korea Advanced Institute of Science and Technology, Daejeon (KR)

(21) Appl. No.: 16/364,445

(22) Filed: Mar. 26, 2019

(30) Foreign Application Priority Data
Feb. 21, 2019 (KR) 10-2019-0020601

(51) Int. Cl. H04N 13/383; G06F 3/01; G06F 3/042; G06F 3/041; G06F 3/0488

(52) U.S. Cl. CPC H04N 13/383; G06F 3/017; G06F 3/0488; G06F 3/0426; G06F 3/0416; G06F 3/013

(57) ABSTRACT

Disclosed are an input method and apparatuses performing the input method. The input method includes selecting, in response to a gaze of a user, a keyboard corresponding to the gaze from a plurality of keyboards in a virtual reality and inputting, in response to a touch of the user, a key corresponding to the touch among a plurality of keys included in the selected keyboard.

### CROSS-REFERENCE TO RELATED APPLICATION(S)

This application claims the priority benefit of Korean Patent Application No. 10-2019-0020601 filed on Feb. 21, 2019, in the Korean Intellectual Property Office, the disclosure of which is incorporated herein by reference for all purposes.

### BACKGROUND

### 1. Field

One or more example embodiments relate to an input method and apparatuses performing the method.

### 2. Description of Related Art

A face wearable device is implemented as a display device for a virtual reality and a smart glass such as Google glass and Vuzix M series. The face wearable device is a device that is highly accessible to a display and, simultaneously, in a form suitable for tracking eye movements. Eye-tracking device manufacturers are commercializing glass-type eye-tracking devices and virtual reality display devices capable of eye-tracking.

However, the face wearable device has a limited and insufficient input space to perform a complicated touch input such as a text input.

For example, the smart glass uses a touch pad attached to a long and narrow temple as an input device or inputs text through a voice input.

The touch pad may be useful for performing one-dimensional operation such as scrolling, but may be limited in performing a complicated input such as a text input. In order to solve the problem of limited input space, researchers have designed a method of performing a plurality of touch inputs for inputting a single character or a method of inputting text using a complicated unistroke gesture.

When performing the text input through the voice input, the face wearable device may perform the text input intuitively with a high speed, but private information may not be protected.

In addition, since inputting with the face wearable device may attract attention of people around, a use of the face wearable device may be restricted depending on a situation.

In terms of performing the text input using a voice in a public place, the face wearable device may be unsuitable for inputting a password and restricted for use in public places where quietness is required.

### SUMMARY

An aspect provides technology for inputting keys or characters corresponding to a gaze and a touch of a user in response to the gaze and the touch.

According to an aspect, there is provided an input method including selecting, in response to a gaze of a user, a keyboard corresponding to the gaze from a plurality of keyboards in a virtual reality and inputting, in response to a touch of the user, a key corresponding to the touch among a plurality of keys included in the selected keyboard.

The selecting may include displaying a gaze cursor representing the gaze in the virtual reality and selecting a keyboard corresponding to the gaze cursor from the plurality of keyboards as the keyboard corresponding to the gaze.

The selecting of the keyboard corresponding to the gaze cursor as the keyboard corresponding to the gaze may include determining whether the gaze cursor is located in a range of a keyboard among the plurality of keyboards and selecting, when the gaze cursor is located in the range of the keyboard, the keyboard as the keyboard corresponding to the gaze.

Coordinates of the gaze cursor may be determined based on a gaze position corresponding to the gaze in the virtual reality and a range of a keyboard corresponding to the gaze position.

An x coordinate of the gaze cursor may be determined to be the same as an x coordinate of the gaze position.

A y coordinate of the gaze cursor may be determined based on a predetermined position at a lower end of the keyboard corresponding to the gaze position.

The selecting of the keyboard corresponding to the gaze may further include providing a selection-completed feedback associated with the selected keyboard and displaying an input field in which at least one of the plurality of keys is to be input, in the selected keyboard.

The selection-completed feedback may be a feedback indicating that the selected keyboard is selected, and may be a visualization feedback for at least one of highlighting and enlarging the selected keyboard.

The inputting may include selecting a key corresponding to the touch from the plurality of keys and inputting the selected key.

The touch may be one of a tapping gesture and a swipe gesture.

The tapping gesture may be a gesture of a user tapping a predetermined point.

The swipe gesture may be a gesture of the user touching a predetermined point and then, swiping while still touching.

The selecting of the key corresponding to the touch may include selecting, when the touch is the tapping gesture, a center key at a center of the plurality of keys and selecting, when the touch is the swipe gesture, a remaining key other than the center key from the plurality of keys.

The selecting of the remaining key may include selecting a key corresponding to a moving direction of the swipe gesture from the plurality of keys as the remaining key.

The inputting of the key corresponding to the touch may further include displaying a touch cursor representing the touch on the key corresponding to the touch and displaying the selected key in an input field in which the key corresponding to the touch is to be input.

According to another aspect, there is provided a user interface apparatus including a memory and a controller configured to select, in response to a gaze of a user, a keyboard corresponding to the gaze from a plurality of keyboards in a virtual reality and input, in response to a touch of the user, a key corresponding to the touch among a plurality of keys included in the selected keyboard.

The controller may be configured to display a gaze cursor representing the gaze in the virtual reality and select a keyboard corresponding to the gaze cursor from the plurality of keyboards as the keyboard corresponding to the gaze.

The controller may be configured to determine whether the gaze cursor is located in a range of a keyboard among the plurality of keyboards and select, when the gaze cursor is located in the range of the keyboard, the keyboard as the keyboard corresponding to the gaze.

Coordinates of the gaze cursor may be determined based on a gaze position corresponding to the gaze in the virtual reality and a range of a keyboard corresponding to the gaze position.

An x coordinate of the gaze cursor may be determined to be the same as an x coordinate of the gaze position.

A y coordinate of the gaze cursor may be determined based on a predetermined position at a lower end of the keyboard corresponding to the gaze position.

The controller may be configured to provide a selection-completed feedback associated with the selected keyboard and display an input field in which at least one of the plurality of keys is to be input, in the selected keyboard.

The selection-completed feedback may be a feedback indicating that the selected keyboard is selected, and may be a visualization feedback for at least one of highlighting and enlarging the selected keyboard.

The controller may be configured to select a key corresponding to the touch from the plurality of keys and input the selected key.

The touch may be one of a tapping gesture and a swipe gesture.

The tapping gesture may be a gesture of a user tapping a predetermined point, and

The swipe gesture may be a gesture of the user touching a predetermined point and swiping while still touching.

When the touch is the tapping gesture, the controller may be configured to select a center key at a center of the plurality of keys. When the touch is the swipe gesture, the controller may be configured to select a remaining key other than the center key from the plurality of keys.

The controller may be configured to select a key corresponding to a moving direction of the swipe gesture from the plurality of keys as the remaining key.

The controller may be configured to display a touch cursor representing the touch on the key corresponding to the touch and display the selected key in an input field in which the key corresponding to the touch is to be input.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a text input system according to an example embodiment;

FIG. 2 is a block diagram illustrating a user interface apparatus of FIG. 1;

FIG. 3 is a diagram illustrating an example of a keyboard selecting operation of the user interface apparatus of FIG. 1;

FIG. 4A is a diagram illustrating an example of a key input operation of the user interface apparatus of FIG. 1;

FIG. 4B is a diagram illustrating another example of a key input operation of the user interface apparatus of FIG. 1;

FIG. 4C is a diagram illustrating still another example of a key input operation of the user interface apparatus of FIG. 1;

FIG. 5A is a diagram illustrating an example of a plurality of keyboards;

FIG. 5B is a diagram illustrating another example of a plurality of keyboards;

FIG. 5C is a diagram illustrating still another example of a plurality of keyboards;

FIG. 5D is a diagram illustrating yet another example of a plurality of keyboards;

FIG. 6A is a diagram illustrating an example of an operation of generating a gaze cursor;

FIG. 6B is a diagram illustrating an example of generating a gaze cursor according to the example of FIG. 6A;

FIG. 7 is a diagram illustrating an example of an input field;

FIG. 8 is a diagram illustrating an example of a touch cursor; and

FIG. 9 is a flowchart illustrating an operation of the user interface apparatus of FIG. 1.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the inventive concepts. As used herein, the term “and/or” includes any and all combinations of one or more of the associated listed items.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

Hereinafter, example embodiments will be described in detail with reference to the accompanying drawings. It should be understood, however, that there is no intent to limit this disclosure to the particular example embodiments disclosed. Like numbers refer to like elements throughout the description of the figures.

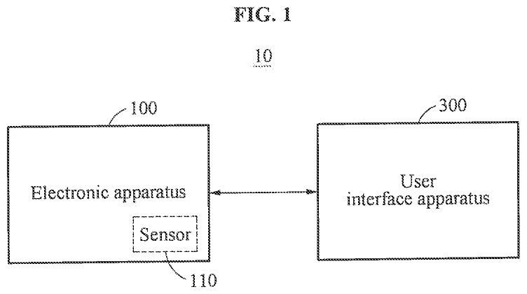

FIG. 1 is a block diagram illustrating a text input system according to an example embodiment.

A text input system 10 includes an electronic apparatus 100 and a user interface apparatus 300.

The electronic apparatus 100 may be a wearable device to be worn by a user. For example, the wearable device may be a wearable device for virtual reality to be worn on a head of the user, and may be various devices such as Google glass, Vuzix M series, a glass-type wearable device, a display for virtual reality, and the like.

The electronic apparatus 100 may generate a virtual reality or an augmented reality. A sensor 110 included in the electronic apparatus 100 may sense a gaze of the user and transmit the gaze of the user to the user interface apparatus 300. The gaze of the user may be, for example, a gaze of the user viewing the virtual reality.

The electronic apparatus 100 may be various devices such as a personal computer (PC), a data server, and a portable electronic device. The portable electronic device may be implemented as, for example, a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), a handheld game console, an e-book, and a smart device. The smart device may be implemented as a smart watch or a smart band.

The user interface apparatus 300 may be an interface apparatus for controlling or operating the electronic apparatus 100. Although FIG. 1 illustrates that the user interface apparatus 300 is provided external to the electronic apparatus 100, embodiments are not limited thereto. For example, the user interface apparatus 300 may be implemented in the electronic apparatus 100, implemented as a separate apparatus capable of communicating with the electronic apparatus 100, and implemented in an electronic apparatus capable of communicating with the electronic apparatus 100. Also, the sensor 110 included in the electronic apparatus 100 of FIG. 1 may also be implemented in the user interface apparatus 300. The electronic apparatus capable of communicating with the electronic apparatus 100 may be implemented in the same manner as the electronic apparatus 100 described above.

The user interface apparatus 300 may sense the touch of the user. The user interface apparatus 300 may input a key or character corresponding to the gaze and the touch of the user in the virtual reality generated in the electronic apparatus 100 in response to the gaze and the touch.

The user interface apparatus 300 may enable an efficient text input for which the gaze and the touch of the user are complementarily performed, thereby reducing an eye fatigue of the user, reducing an arm fatigue of the user, enabling subtle manipulation, and increasing a speed and accuracy of text input.

The user interface apparatus 300 may perform the text input at a lower level of gaze response accuracy and precision when compared to a method of inputting text using a gaze only. The user interface apparatus 300 may perform the text input at an increased speed when compared to a method of inputting text using a touch only.

Since the user interface apparatus 300 responses to the gaze and the touch of the user, a number of keyboards corresponding to the gaze and a number of keys corresponding to the touch may be dependent. Accordingly, the user interface apparatus 300 may overcome a limited input space of a touch pad, more efficiently utilize the space, and flexibly design the number of keyboards and the number of keys.

The user may input text using the gaze and the touch alternately and thus, may feel less difficulty in cognition rather than using a motion of the head or a wrist in addition to the gaze.

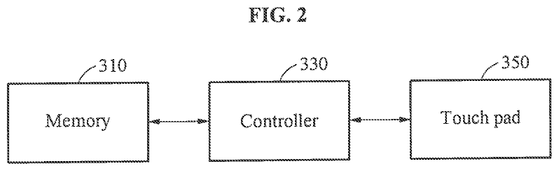

FIG. 2 is a block diagram illustrating the user interface apparatus 300 of FIG. 1.

The user interface apparatus 300 includes a memory 310, a controller 330, and a touch pad 350.

The memory 310 may store instructions or a program to be executed by the controller 330. The instructions may include, for example, instructions for executing an operation of the controller 330.

The controller 330 may generate a plurality of keyboards in a virtual reality provided by the electronic apparatus 100 in response to a text input signal being transmitted from the electronic apparatus 100. In this example, the text input signal may be a trigger signal for triggering a text input of the user inputting text to the electronic apparatus 100. The trigger signal may be generated in the electronic apparatus 100 based on a manipulation of the user.

Each of the plurality of keyboards may be a virtual keyboard and include a plurality of keys or characteristics in a keyboard range. The keyboard range, for example, a keyboard shape or a keyboard layout may be a range including the plurality of keys, and may have various shapes such as a triangle, a quadrangle, a circle, and the like.

The controller 330 may select a keyboard corresponding to a gaze of the user from a plurality of keyboards in response to the gaze of the user. In this example, the controller 330 may respond to the gaze of the user and may not respond to a touch of the user.

The controller 330 may display or generate a gaze cursor representing the gaze of the user in the virtual reality in response to the gaze of the user. The gaze cursor may be displayed at a position in which a plurality of keys included in the selected keyboard is not disturbed. The gaze cursor may move according to the gaze of the user until the keyboard is selected.

The controller 330 may determine coordinates of the gaze cursor based on a gaze position corresponding to the gaze in the virtual reality and a range or a height of a keyboard corresponding to the gaze position. An x coordinate of the gaze cursor may be determined to be the same as an x coordinate of the gaze position. A y coordinate of the gaze cursor may be determined based on a predetermined position at a lower end of the keyboard corresponding to the gaze position.

Thereafter, the controller 330 may select a keyboard corresponding to the gaze cursor among the plurality of keyboard to be the keyboard corresponding to the gaze of the user.

For example, the controller 330 may determine whether the gaze cursor is located in a range of a keyboard among the plurality of keyboards for a predetermined period of time. The predetermined period of time may be a determination reference time used by the controller 330 to determine that the gaze of the user is a gaze for selecting a keyboard.

When the gaze cursor is located in the range of the keyboard for the predetermined period of time, the controller 330 may select the keyboard as the keyboard corresponding to the gaze.

When the keyboard is selected, the controller 330 may output a selection-completed feedback associated with the selected keyboard to the virtual reality in the electronic apparatus 100.

The selection-completed feedback may be a feedback or notification indicating that the keyboard corresponding to the gaze of the user is selected. Also, the selection-completed feedback may be a visualization feedback for highlighting and/or enlarging the selected keyboard.

Although the visualization feedback for highlighting and/or enlarging the selected keyboard is described as an example of the selection-completed feedback, a type of the selection-completed feedback is not limited to the example. The selection-completed feedback may be various types of feedbacks, for example, an auditory feedback and a tactile feedback indicating that a keyboard corresponding to a gaze of a user is selected. The auditory feedback may be a notification sound. The tactile feedback may be a notification vibration.

After the keyboard is selected or the selection-completed feedback is provided, the controller 330 may maintain a position of the gaze position instead of sensing or tracking the gaze of the user. The gaze cursor may be displayed at a fixed position instead of moving according to the gaze of the user.

Also, the controller 330 may display or generate an input field in which at least one of the plurality of keys included in the selected keyboard is to be input, in the selected keyboard. The input field may be displayed at a position in which the plurality of keys included in the selected keyboard is not disturbed.

The controller 330 may select a key corresponding to a touch of the user among the plurality of keys included in the selected keyboard in response to the touch of the user and input the selected key. In this example, the controller 330 may display or generate a touch cursor representing the touch of the user on the key corresponding to the touch in the virtual reality in response to the touch. The controller 330 may respond to the touch of the user and may not respond to the gaze of the user. A touch gesture corresponding to each of the plurality of keys may be set in advance.

The touch of the user may be a touch of the user sensed by the touch pad 350. Also, the touch of the user may be a touch of the user sensed by a separate interface apparatus implemented in the electronic apparatus 100 or an electronic apparatus capable of communicating with the electronic apparatus 100.

The touch of the user may be one of a tapping gesture and a swipe gesture. The tapping gesture may be a gesture of a user tapping a predetermined point. The swipe gesture may be a gesture of the user touching a predetermined point and then, swiping, for example, moving or sliding while still touching.

When the touch is the tapping gesture, the controller 330 may select a center key at a center of the plurality of keys included in the selected keyboard. The center key may be a key for which the tapping gesture is set as a touch gesture corresponding to the center key.

When the touch is the swipe gesture, the controller 330 may select a remaining key other than the center key from the plurality of keys included in the selected keyboard. The remaining key may be a key for which the swipe gesture is set as a touch gesture corresponding to the remaining key. The remaining key may be one of keys arranged around the center key. A key direction indicating a key may be set for the remaining key. The key direction may be various directions such as upward, downward, leftward, and rightward directions.

The controller 330 may select a key corresponding to a moving direction of the swipe gesture from the plurality of keys included in the selected keyboard as the remaining key. The key corresponding to the moving direction of the swipe gesture may be a key of which a key direction is the same as the moving direction of the swipe gesture.

The controller 330 may input the selected key. The controller 330 may display the selected key in the input field. The controller 330 may provide the selected key to the electronic apparatus 100 as a text input signal.

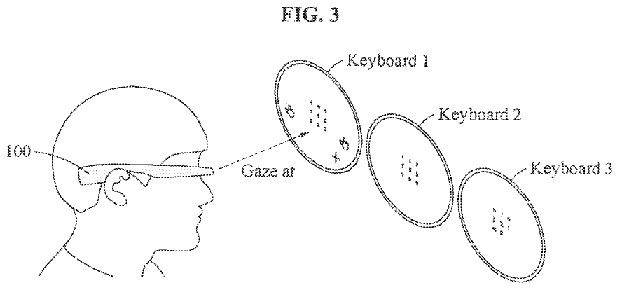

FIG. 3 is a diagram illustrating an example of a keyboard selecting operation of the user interface apparatus 300 of FIG. 1.

The controller 330 may generate three circular keyboards, for example, a keyboard 1 through a keyboard 3 in a virtual reality. Each of the circular keyboards 1 through 3 may include a plurality of keys in a 3×3 structure.

The controller 330 may display a gaze cursor on a first keyboard, for example, the keyboard 1 among the circular keyboards 1 through 3 based on a gaze position in the virtual reality according to a gaze of a user sensed by the electronic apparatus 100. The gaze of the user may be a gaze of the user viewing the keyboard 1.

When the gaze cursor is located in a range of the first keyboard for a predetermined period of time, the controller 330 may select the keyboard 1 as a keyboard corresponding to the gaze of the user.

When the keyboard 1 is selected, the controller 330 may fix the gaze cursor such that a keyboard change does not occur in response to a touch of the user.

As such, the user may select a desired keyboard by viewing the keyboard among a plurality of keyboard for a predetermined period of time.

Also, the user may freely change a keyboard to be selected while moving an eye of the user until the user receives a selection-completed feedback.

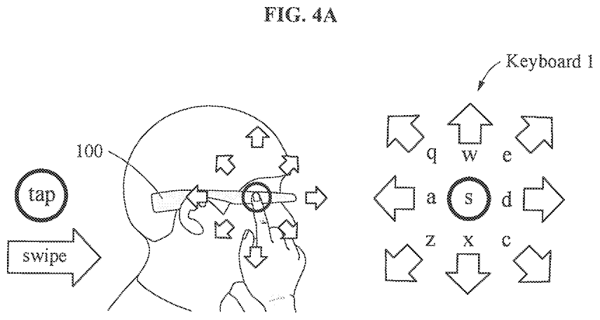

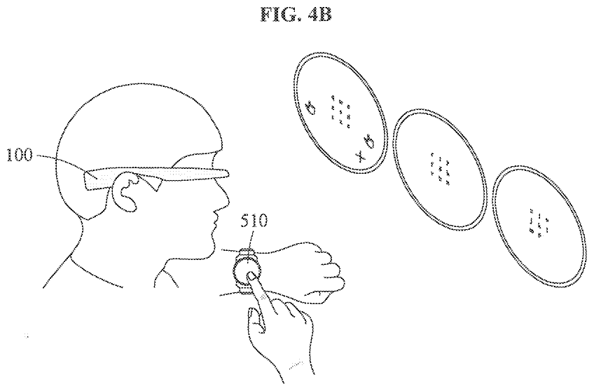

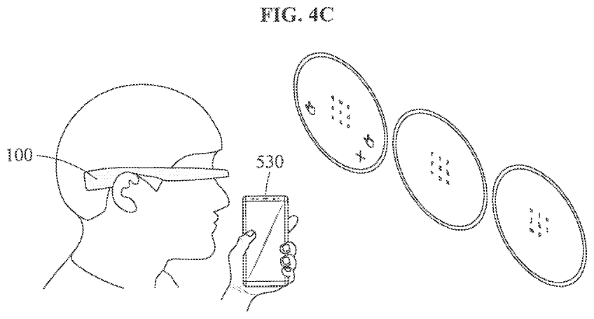

FIG. 4A is a diagram illustrating an example of a key input operation of the user interface apparatus 300 of FIG. 1, FIG. 4B is a diagram illustrating another example of a key input operation of the user interface apparatus 300 of FIG. 1, and FIG. 4C is a diagram illustrating still another example of a key input operation of the user interface apparatus 300 of FIG. 1.

For ease of description, it is assumed that the electronic apparatus 100 is implemented as a glass-type wearable device in the examples of FIGS. 4A through 4C.

Referring to FIG. 4A, a touch of a user may be a touch sensed by a separate interface apparatus implemented in the electronic apparatus 100. Referring to FIGS. 4B and 4C, a touch of a user may be a touch sensed by separate interface apparatuses implemented in electronic apparatuses 510 and 530 capable of communicating with the electronic apparatus 100. Also, a touch of the user may be a touch of the user touching the user interface apparatus 300. For example, the user interface apparatus 300 may be implemented in the electronic apparatus 100 or the electronic apparatuses 510 and 530 capable of communicating with the electronic apparatus 100 to sense a touch of the user.

The controller 330 may input a key corresponding to a touch of the user among a plurality of keys included in a first keyboard, for example, a keyboard 1 in response to the touch of the user.

When the touch of the user is a tapping gesture, the controller 330 may input s which is a center key of the keyboard 1 as the key corresponding to the touch of the user. In this example, the controller 330 may display a touch cursor on s.

When the touch of the user is a rightwardly swiping gesture, the controller 330 may input d of which a key direction is a rightward direction among keys arranged around the center key of the keyboard 1, as the key corresponding to the touch of the user. In this example, the controller 330 may display a touch cursor on d.

As such, the user may input a desired key to be input by performing a touch gesture corresponding to the key to be input without need to view a touch pad.

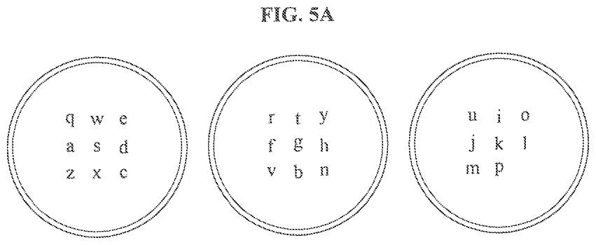

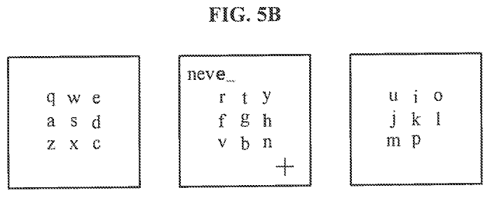

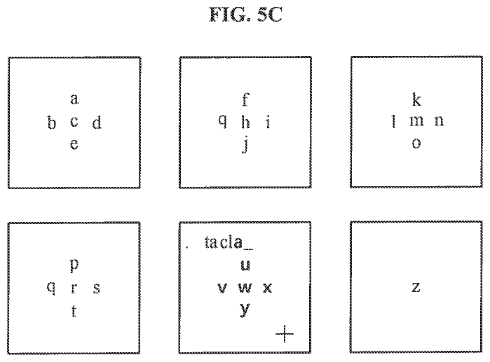

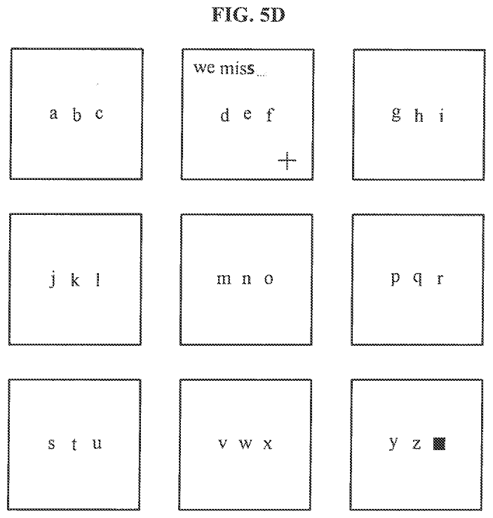

FIG. 5A is a diagram illustrating an example of a plurality of keyboards, FIG. 5B is a diagram illustrating another example of a plurality of keyboards, FIG. 5C is a diagram illustrating still another example of a plurality of keyboards, and FIG. 5D is a diagram illustrating yet another example of a plurality of keyboards.

In the examples of FIGS. 5A and 5B, a plurality of keyboards may include three keyboards in a 1×3 structure. In the example of FIG. 5C, a plurality of keyboards may include six keyboards in a 2×3 structure. In the example of FIG. 5D, a plurality of keyboards may include nine keyboards in a 3×3 structure. For example, a plurality of keyboards may have a circular keyboard range as shown in FIG. 5A or a quadrangular keyboard range as shown in FIGS. SB through 5D.

Referring to FIGS. SA and SB, the plurality of keyboards may each include a plurality of keys, for example, eight or nine keys. In this example, the plurality of keys may be in a 3×3 structure. A touch gesture of a user for inputting the keys in the 3×3 structure may be nine gestures including one tapping gesture and eight swipe gestures.

Referring to FIG. 5C, the plurality of keyboards may each include a plurality of keys, for example, one or five keys. In this example, the plurality of keys may be in a+ structure. A touch gesture of a user for inputting the keys in the + structure may be five gestures including one tapping gesture and four swipe gestures.

Referring to FIG. 5D, the plurality of keyboards may each include a plurality of keys, for example, three keys. In this example, the plurality of keys may be in a − structure. A touch gesture of a user for inputting the keys in the − structure may be three gestures including one tapping gesture and two swipe gestures.

The plurality of keyboards and the plurality of keys may be previously set based on a detailed design and stored. A number of the plurality of keyboards and a number of the plurality of keys may be set to be adjusted with respect to each other.

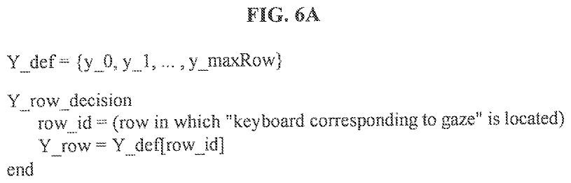

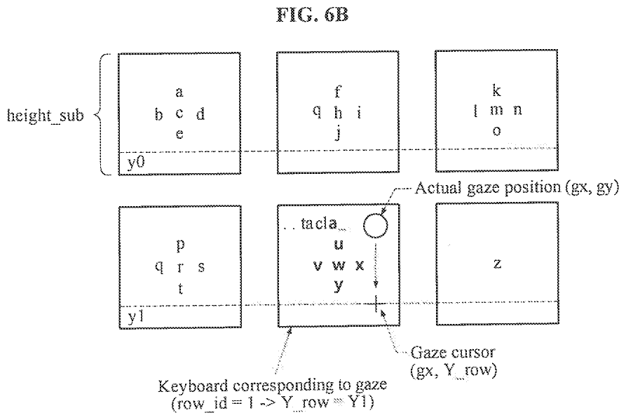

FIG. 6A is a diagram illustrating an example of an operation of generating a gaze cursor and FIG. 6B is a diagram illustrating an example of generating a gaze cursor according to the example of FIG. 6A.

For ease of description, it is assumed that a plurality of keyboards is configured in a 2×3 structure in the examples of FIGS. 6A and 6B.

FIG. 6A illustrates an algorithm for generating a gaze cursor. The controller 330 may generate a gaze cursor in a virtual reality using the algorithm of FIG. 6A.

When a user gazes at a keyboard located in the middle of a second row, the controller 330 may determine a position of a gaze cursor based on a gaze position of the user. For example, the controller 330 may determine an x coordinate of the gaze cursor to be gx which is the same as an x coordinate, gx, of the gaze position of the user.

The controller 330 may determine y1 as a y coordinate, for example, Y row of the gaze cursor among predetermined positions y0 and y1 corresponding to the gaze position of the user. The predetermined position may be coordinates obtained by substituting the gaze position of the user with a predetermined value based on a matrix of a keyboard corresponding to the gaze position.

The controller 330 may calculate a keyboard row, for example, row_id corresponding to the gaze position of the user based on a y coordinate “gy” of the gaze position. In this example, the keyboard row corresponding to the gaze position of the user may be a row in which a keyboard corresponding to the gaze of the user is located.

Thereafter, the controller 330 may determine the y coordinate of the gaze cursor to be a predetermined position “Y_def[row_id]” corresponding to the calculated keyboard row. The predetermined position may be a position set within the gaze of the user so as not to interfere with a touch cursor, an input field, and a plurality of keys and not to disturb the user. The set position may be a lower end of a keyboard corresponding to the gaze position of the user in the gaze of the user.

The user may use the gaze cursor provided by the user interface apparatus 300 to select a keyboard by manipulating the gaze cursor or moving an eye and verify the selected keyboard and a keyboard to be selected by the user.

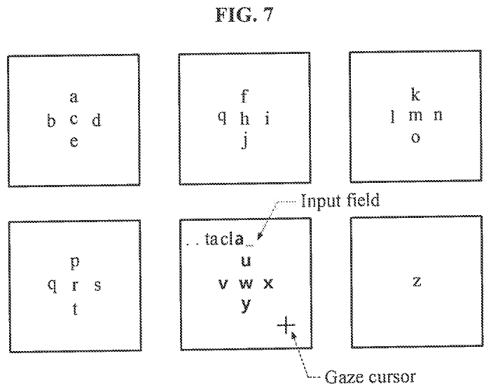

FIG. 7 is a diagram illustrating an example of an input field.

Referring to FIG. 7, the controller 330 may display an input field on a plurality of keys included in a selected keyboard. In the input field, a key corresponding to a touch of a user among the plurality of keys included in the selected keyboard may be input.

The user may confirm the key input by the user through the input field provided by the user interface apparatus 300.

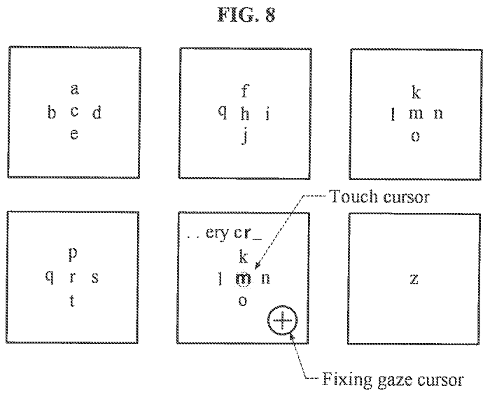

FIG. 8 is a diagram illustrating an example of a touch cursor.

The controller 330 may display a touch cursor using relative coordinates based on a touch start point.

When a touch is a tapping gesture, the controller 330 may display the touch cursor on a center key at a center of a plurality of keys included in a selected keyboard.

When a touch is a swipe gesture, the controller 330 may display the touch cursor on the center key at a moment the touch is input and then, display the touch cursor moving to a relative position in response to the swipe gesture.

A user may use the touch cursor provided by the user interface apparatus 300 to select a key by manipulating, for example, tapping or swiping the touch cursor and verify a key to be input by the user.

When the user is skilled in manipulating the touch cursor, the user may input the key by performing a touch motion corresponding to a plurality of keys irrespective of a touch position without viewing the touch cursor.

As described with reference to FIGS. 6A through 8, a gaze cursor, the touch cursor, and an input field may be generated in a gaze of the user and verified in a field of view of the user viewing the keyboard. In this example, the gaze cursor, the touch cursor, and the input field may be displayed until a text input is terminated.

The gaze cursor, the touch cursor, and the input field may be, for example, a graphical user interface (GUI) provided for convenience of the user.

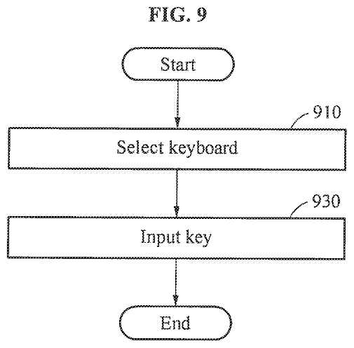

FIG. 9 is a flowchart illustrating an operation of the user interface apparatus 300 of FIG. 1.

Referring to FIG. 9, in operation 910, the controller 330 may select, in response to a gaze of a user, a keyboard corresponding to the gaze from a plurality of keyboards in a virtual reality.

In operation 930, the controller 330 may input, in response to a touch of the user, a key corresponding to the touch among a plurality of keys included in the selected keyboard.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. An input method using a user interface apparatus comprising:
selecting, in response to a gaze of a user, a keyboard corresponding to the gaze from a plurality of keyboards in a virtual reality; and
inputting, in response to a touch of the user, a key corresponding to the touch among a plurality of keys included in the selected keyboard, and
wherein the selected keyboard is changed according to movement of the gaze of the user before the inputting,
wherein the user interface apparatus does not respond to the gaze during the inputting, and
wherein the gaze and touch constitute a unit input sequence.

2. The input method of claim 1, wherein the selecting comprises:
displaying a gaze cursor representing the gaze in the virtual reality; and
selecting a keyboard corresponding to the gaze cursor from the plurality of keyboards as the keyboard corresponding to the gaze.

3. The input method of claim 2, wherein the selecting of the keyboard corresponding to the gaze cursor as the keyboard corresponding to the gaze comprises:
determining whether the gaze cursor is located in a range of a keyboard among the plurality of keyboards; and
selecting, when the gaze cursor is located in the range of the keyboard, the keyboard as the keyboard corresponding to the gaze.

4. The input method of claim 3, wherein coordinates of the gaze cursor are determined based on a gaze position corresponding to the gaze in the virtual reality and a range of a keyboard corresponding to the gaze position,
an x coordinate of the gaze cursor is determined to be the same as an x coordinate of the gaze position, and
a y coordinate of the gaze cursor is determined based on a predetermined position at a lower end of the keyboard corresponding to the gaze position.

5. The input method of claim 2, wherein the selecting of the keyboard corresponding to the gaze further comprises:
providing a selection-completed feedback associated with the selected keyboard; and
displaying an input field in which at least one of the plurality of keys is to be input, in the selected keyboard.

6. The input method of claim 5, wherein the selection-completed feedback is a feedback indicating that the selected keyboard is selected, and is a visualization feedback for at least one of highlighting and enlarging the selected keyboard.

7. The input method of claim 1, wherein the inputting comprises:
selecting a key corresponding to the touch from the plurality of keys; and
inputting the selected key.

8. The input method of claim 7, wherein the touch is one of a tapping gesture and a swipe gesture,
the tapping gesture is a gesture of a user tapping a predetermined point, and
the swipe gesture is a gesture of the user touching a predetermined point and then, swiping while still touching.

9. The input method of claim 8, wherein the selecting of the key corresponding to the touch comprises:
selecting, when the touch is the tapping gesture, a center key at a center of the plurality of keys; and
selecting, when the touch is the swipe gesture, a remaining key other than the center key from the plurality of keys, and
the selecting of the remaining key comprises:
selecting a key corresponding to a moving direction of the swipe gesture from the plurality of keys as the remaining key.

10. The input method of claim 7, wherein the inputting of the key corresponding to the touch further comprises:
displaying a touch cursor representing the touch on the key corresponding to the touch; and
displaying the selected key in an input field in which the key corresponding to the touch is to be input.

11. A user interface apparatus comprising:
a memory; and
a controller configured to select, in response to a gaze of a user, a keyboard corresponding to the gaze from a plurality of keyboards in a virtual reality and input, in response to a touch of the user, a key corresponding to the touch among a plurality of keys included in the selected keyboard, and
wherein the controller changes the selected keyboard according to movement of the gaze of the user before the inputting,
wherein the controller does not respond to the gaze during the inputting, and
wherein the gaze and touch constitute a unit input sequence.

12. The user interface apparatus of claim 11, wherein the controller is configured to display a gaze cursor representing the gaze in the virtual reality and select a keyboard corresponding to the gaze cursor from the plurality of keyboards as the keyboard corresponding to the gaze.

13. The user interface apparatus of claim 12, wherein the controller is configured to determine whether the gaze cursor is located in a range of a keyboard among the plurality of keyboards and select, when the gaze cursor is located in the range of the keyboard, the keyboard as the keyboard corresponding to the gaze.

14. The user interface apparatus of claim 13, wherein coordinates of the gaze cursor are determined based on a gaze position corresponding to the gaze in the virtual reality and a range of a keyboard corresponding to the gaze position,
an x coordinate of the gaze cursor is determined to be the same as an x coordinate of the gaze position, and
a y coordinate of the gaze cursor is determined based on a predetermined position at a lower end of the keyboard corresponding to the gaze position.

15. The user interface apparatus of claim 12, wherein the controller is configured to provide a selection-completed feedback associated with the selected keyboard and display an input field in which at least one of the plurality of keys is to be input, in the selected keyboard.

16. The user interface apparatus of claim 15, wherein the selection-completed feedback is a feedback indicating that the selected keyboard is selected, and is a visualization feedback for at least one of highlighting and enlarging the selected keyboard.

17. The user interface apparatus of claim 11, wherein the controller is configured to select a key corresponding to the touch from the plurality of keys and input the selected key.

18. The user interface apparatus of claim 17, wherein the touch is one of a tapping gesture and a swipe gesture,
the tapping gesture is a gesture of a user tapping a predetermined point, and
the swipe gesture is a gesture of the user touching a predetermined point and swiping while still touching.

19. The user interface apparatus of claim 18, wherein when the touch is the tapping gesture, the controller is configured to select a center key at a center of the plurality of keys,
when the touch is the swipe gesture, the controller is configured to select a remaining key other than the center key from the plurality of keys, and
the controller is configured to select a key corresponding to a moving direction of the swipe gesture from the plurality of keys as the remaining key.

20. The user interface apparatus of claim 17, wherein the controller is configured to display a touch cursor representing the touch on the key corresponding to the touch and display the selected key in an input field in which the key corresponding to the touch is to be input.
